(19) United States
(12) Patent Application Publication
(10) Pub. No.: US 2026/0188944 A1
(43) Pub. Date: Jul. 2, 2026

(54) PLUGGABLE CONNECTING DEVICE

(71) Applicants: NEXTRONICS ENGINEERING CORP., NEW TAIPEI CITY (TW); NEXTRONICS ENGINEERING(GUANGDONG) CORP., Guangzhou City (CN)

(72) Inventors: CHIH-HSIUNG HSU, NEW TAIPEI CITY (TW); YONG ZHANG, Guangzhou City (CN); JIAN-ZHAO PENG, Guangzhou City (CN)

(21) Appl. No.: 19/021,201

(22) Filed: Jan. 15, 2025

(30) Foreign Application Priority Data
Jan. 2, 2025 (CN) 202510006279.2

(51) Int. Cl. H01R 13/625; H01R 13/502; H01R 13/52; H01R 24/38

(52) U.S. Cl. CPC H01R 13/625; H01R 13/5025; H01R 13/5219; H01R 24/38

(57) ABSTRACT

A pluggable connecting device includes a first connector and a second connector. Housings (an inner housing and an outer housing) of the first connector and the second connector each include a power module, a signal module, and a coaxial module. For component reduction and structure simplification, a wire is fixed by potting. A metal shielding shell is disposed on each of the signal module and the coaxial module to provide a shielding effect, such that flexible adjustment can be made to meet different requirements in use, signal interference of different modules in a same connector can be effectively prevented, and a weight can be reduced.

### CROSS-REFERENCE TO RELATED PATENT APPLICATION

This application claims the benefit of priority to China Patent Application No. 202510006279.2, filed on Jan. 2, 2025, in the People's Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a pluggable connecting device, and more particularly to a pluggable connecting device in which a first connector is lockable with a second connector during mating thereof.

### BACKGROUND OF THE DISCLOSURE

An existing connecting device includes a first connector and a second connector. The first connector and the second connector are respectively a male connector and a female connector, and electrical connection can be achieved by mating of the first connector and the second connector. When the first connector is mated with the second connector, a fastening structure is usually arranged between the first connector and the second connector to ensure a stable engagement, such that the first connector is lockable with the second connector. However, it is necessary to place a wire clamping mechanism in the existing connecting device for fixing a connector and a wire, and such configuration may cause an increase in components and structure complication. Moreover, even though a shielding structure is placed in the existing connector, signal interference of different modules in the same connector cannot be effectively prevented.

### SUMMARY OF THE DISCLOSURE

In response to the above-referenced technical inadequacies, the present disclosure provides a pluggable connecting device that can fix a connector and a wire in a convenient manner, so as to achieve component reduction and structure simplification. The present disclosure further provides a pluggable connecting device that has a shielding effect and can effectively prevent signal interference of different modules in the same connector.

In order to solve the above-mentioned problems, one of the technical aspects adopted by the present disclosure is to provide a pluggable connecting device, which includes a first connector and a second connector. The first connector includes an inner housing, a first power module, a first signal module, a first coaxial module, a first tail cover, a tail tube, and a locking module. An interior of the inner housing has an accommodating space, and the accommodating space is exposed at a front end of the inner housing. The first power module, the first signal module, and the first coaxial module are disposed in the accommodating space, and are connected to a first wire. The first tail cover is connected to the inner housing, and is disposed outside of the first wire. The tail tube is connected to the inner housing, and is disposed outside of the first tail cover. The first wire and the first connector are fixed in the first tail cover by potting. The locking module is sleeved onto the inner housing, and is rotatable on the inner housing. A locking portion is disposed on an inner side of the locking module. An elastic member is arranged between the locking module and the inner housing, so as to provide a rotating and resetting force to the locking module. The second connector includes an outer housing, a second power module, a second signal module, a second coaxial module, and a second tail cover. An interior of the outer housing has a slot, the slot is exposed at a front end of the outer housing, and a locking groove is disposed on an outer side of the outer housing. The second power module, the second signal module, and the second coaxial module are disposed in the outer housing, and are connected to a second wire. The second tail cover is connected to the outer housing, and is disposed outside of the second wire. The second wire and the second connector are fixed in the second tail cover by potting. When the first connector is mated with the second connector, the first power module, the first signal module, and the first coaxial module respectively contact and conduct with the second power module, the second signal module, and the second coaxial module, and the first connector is lockable with the second connector by the locking portion of the locking module and the locking groove of the outer housing.

In order to solve the above-mentioned problems, another one of the technical aspects adopted by the present disclosure is to provide a pluggable connecting device, which includes a first connector and a second connector. The first connector includes an inner housing, a first power module, a first signal module, a first fluid module, a first tail cover, a tail tube, and a locking module. An interior of the inner housing has an accommodating space, and the accommodating space is exposed at a front end of the inner housing. The first power module, the first signal module, and the first fluid module are disposed in the accommodating space, and are connected to a first wire. The first tail cover is connected to the inner housing, and is disposed outside of the first wire. The tail tube is connected to the inner housing, and is disposed outside of the first tail cover. The first wire and the first connector are fixed in the first tail cover by potting. The locking module is sleeved onto the inner housing, and is rotatable on the inner housing. A locking portion is disposed on an inner side of the locking module. An elastic member is arranged between the locking module and the inner housing, so as to provide a rotating and resetting force to the locking module. The second connector includes an outer housing, a second power module, a second signal module, a second fluid module, and a second tail cover. An interior of the outer housing has a slot, the slot is exposed at a front end of the outer housing, and a locking groove is disposed on an outer side of the outer housing. The second power module, the second signal module, and the second fluid module are disposed in the outer housing, and are connected to a second wire. The second tail cover is connected to the outer housing, and is disposed outside of the second wire. The second wire and the second connector are fixed in the second tail cover by potting. When the first connector is mated with the second connector, the first power module, the first signal module, and the first fluid module respectively contact and conduct with the second power module, the second signal module, and the second fluid module, and the first connector is lockable with the second connector by the locking portion of the locking module and the locking groove of the outer housing.

Therefore, in the pluggable connecting device provided by the present disclosure, the first connector and the second connector are fixed with the first wire and the second wire by potting, so as to reduce the costs through component reduction and structure simplification.

Furthermore, since a first metal shielding shell is disposed on the first signal module, a second metal shielding shell is disposed on the first coaxial module, a third metal shielding shell is disposed on the second signal module, and a fourth metal shielding shell is disposed on the second coaxial module, the shielding effect can be provided. Through separate arrangement of these metal shielding shells, flexible adjustment can be made to meet different requirements in use, signal interference of different modules in the same connector can be effectively prevented, and a weight can be reduced.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a pluggable connecting device according to an embodiment of the present disclosure;

FIG. 2 is a schematic perspective view of a first connector according to the embodiment of the present disclosure;

FIG. 3 is a schematic exploded perspective view of the first connector according to the embodiment of the present disclosure;

FIG. 4 is a schematic cross-sectional view taken along line IV-IV of FIG. 2;

FIG. 5 is a schematic cross-sectional view of a first coaxial module according to the embodiment of the present disclosure;

FIG. 6 is a schematic perspective view of a second connector according to the embodiment of the present disclosure;

FIG. 7 is a schematic exploded perspective view of the second connector according to the embodiment of the present disclosure;

FIG. 8 is a schematic cross-sectional view taken along line VIII-VIII of FIG. 6;

FIG. 9 is a schematic cross-sectional view of a second coaxial module according to the embodiment of the present disclosure;

FIG. 10 is a schematic exploded perspective view of the first connector according to another embodiment of the present disclosure; and

FIG. 11 is a schematic exploded perspective view of the second connector according to another embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### Embodiments

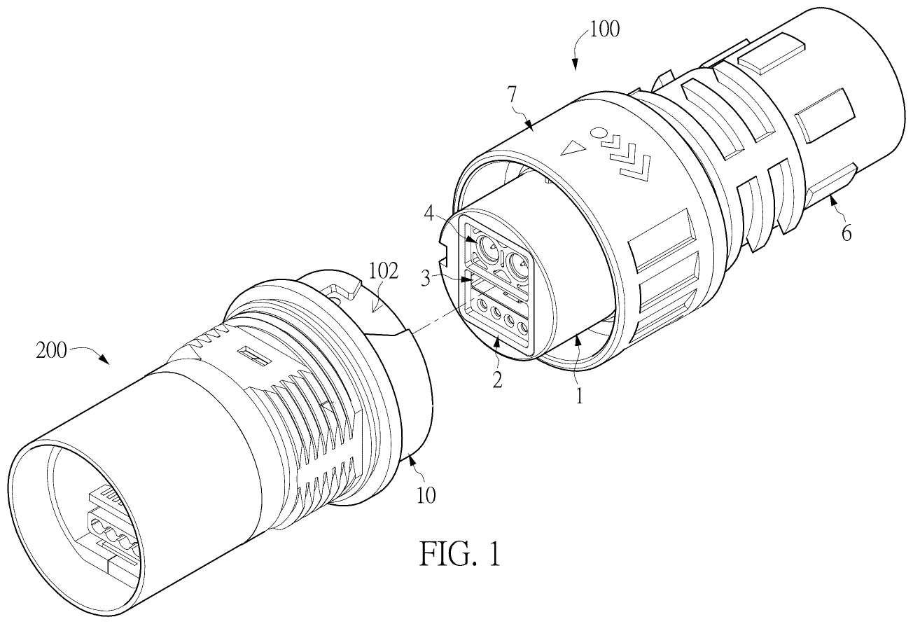

Referring to FIG. 1, the present disclosure provides a pluggable connecting device, which includes a first connector 100 and a second connector 200.

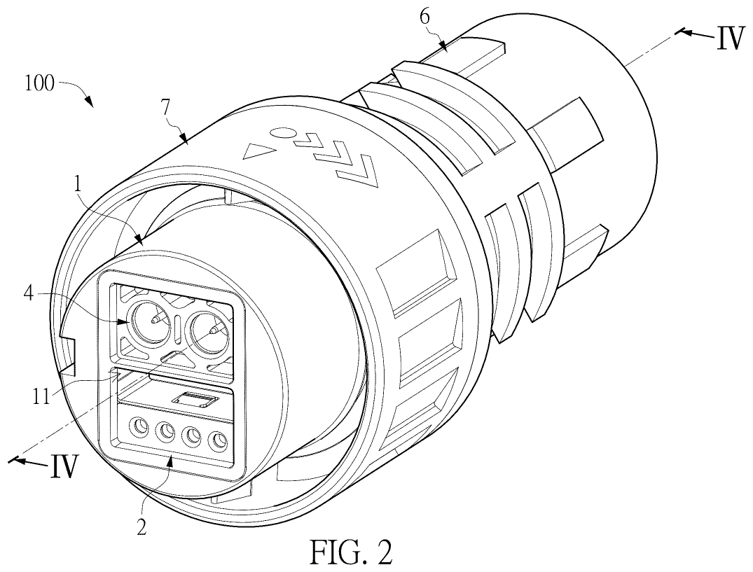

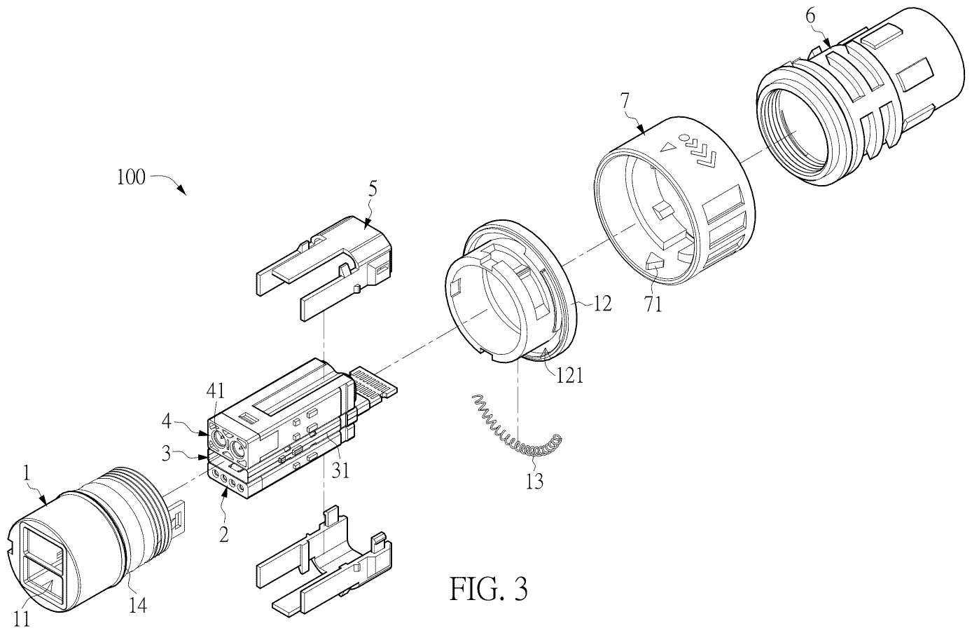

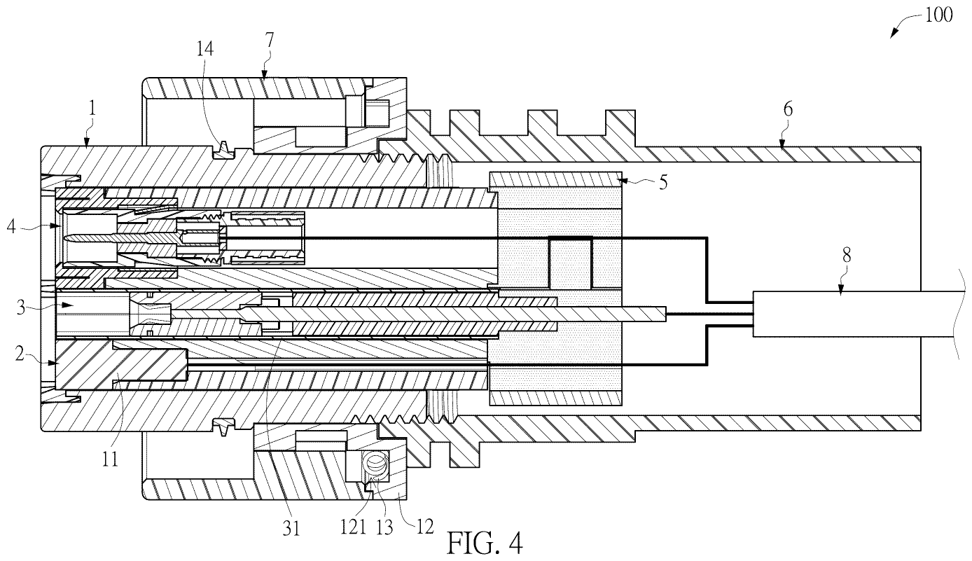

Referring to FIG. 2 to FIG. 4, the first connector 100 includes an inner housing 1, a first power module 2, a first signal module 3, a first coaxial module 4, a first tail cover 5, a tail tube 6, and a locking module 7.

The inner housing 1 can be made of plastic or other insulating materials. Appearance-wise, the inner housing 1 is cylindrical. An interior of the inner housing 1 has an accommodating space 11, and the accommodating space 11 is exposed at a front end of the inner housing 1. The first power module 2, the first signal module 3, and the first coaxial module 4 are disposed in the accommodating space 11, and are arranged to be sequentially stacked. The first signal module 3 is arranged between the first power module 2 and the first coaxial module 4. The first power module 2, the first signal module 3, and the first coaxial module 4 are connected to a first wire 8. A sealing ring 14 can be sleeved onto an outer side of the inner housing 1, and can be a silicon ring.

The first power module 2, the first signal module 3, and the first coaxial module 4 are connector modules, and each include an appropriate number of terminals for transmission of power, signals, etc. A first metal shielding shell 31 is disposed on an outer side of the first signal module 3. The first metal shielding shell 31 is a metal shielding shell made of a metal material, and has a cuboid shape. The first metal shielding shell 31 is sleeved onto the first signal module 3, so as to provide a shielding effect.

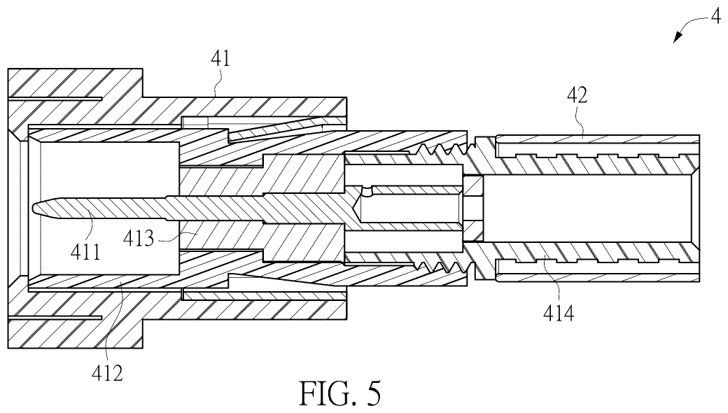

The first coaxial module 4 includes a plurality of first terminal sets 41. Each of the first terminal sets 41 includes a first shaft 411 and a first sleeve 412 (as shown in FIG. 5). The first shaft 411 and the first sleeve 412 are made of metals such as copper. The first sleeve 412 is separately disposed outside of the first shaft 411, and appropriate insulated isolation is formed between the first shaft 411 and the first sleeve 412 by a first insulator 413. A rear end of the first sleeve 412 is connected to a first tubular body 414, and a second metal shielding shell 42 is disposed on an outer side of the first tubular body 414. The second metal shielding shell 42 is a metal shielding shell made of a metal material, and is disposed at a rear end of the first shaft 411 and that of the first sleeve 412, so as to provide the shielding effect.

The first tail cover 5 and the tail tube 6 can be made of plastic or other insulating materials. The first tail cover 5 adopts a two-piece design, and can be connected to the inner housing 1 in a snap-fit manner. The first tail cover 5 is disposed outside of the first wire 8. The tail tube 6 is connected to the inner housing 1 by threaded engagement, and is disposed outside of the first tail cover 5. The first wire 8 and the first connector 100 can be fixed in the first tail cover 5 by potting. In addition, an outer shell (not shown in the drawings) can be formed outside of the tail tube 6 by injection molding.

The locking module 7 is sleeved onto the inner housing 1, and is rotatable on the inner housing 1. Two locking portions 71 are disposed on an inner side of the locking module 7. A ring base 12 is disposed on the outer side of the inner housing 1, and has an accommodating groove 121. An elastic member 13 is disposed in the accommodating groove 121 along an axial direction, so as to be easily assembled with the locking module 7. The locking module 7 is disposed outside of the inner housing 1 and the ring base 12, and the elastic member 13 is arranged between the ring base 12 and the locking module 7. By being arranged between the locking module 7 and the inner housing 1, the elastic member 13 can abut against the locking module 7 and provide a rotating and resetting force.

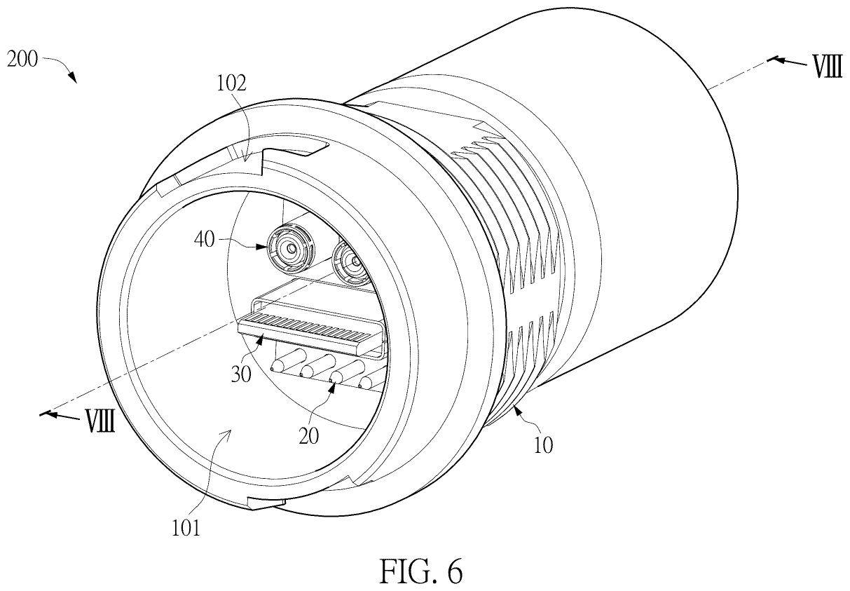

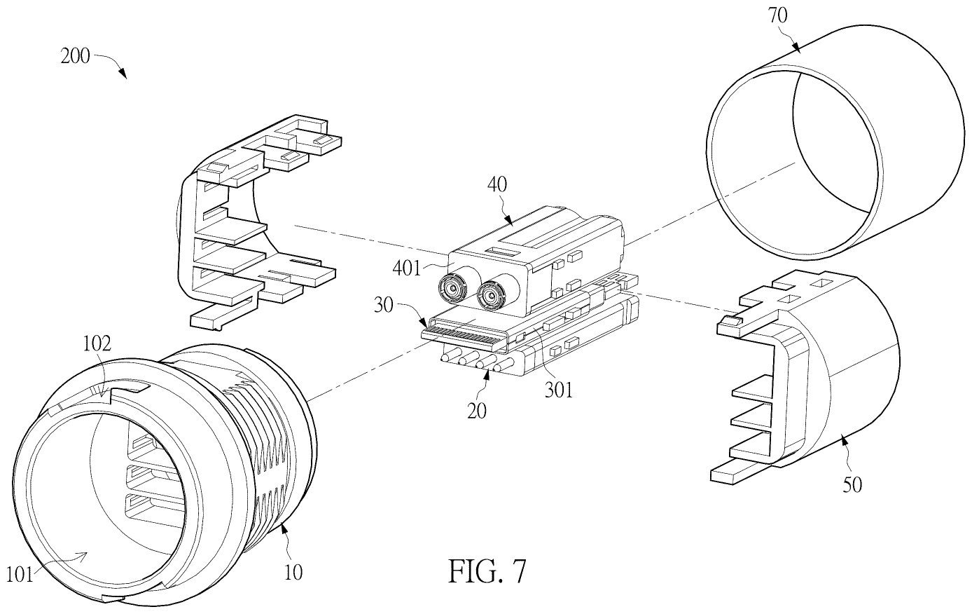

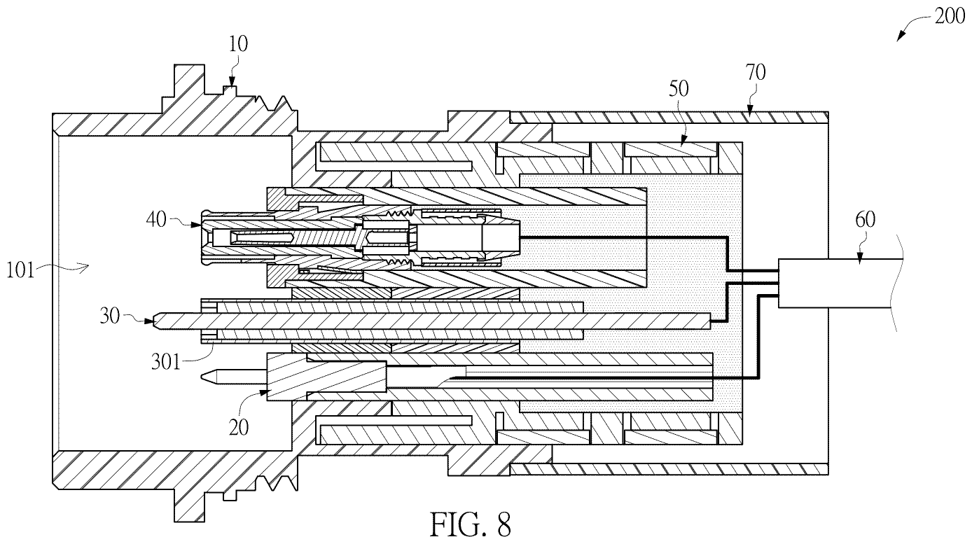

Referring to FIG. 6 to FIG. 8, the second connector 200 includes an outer housing 10, a second power module 20, a second signal module 30, a second coaxial module 40, and a second tail cover 50.

The outer housing 10 can be made of plastic or other insulating materials. Appearance-wise, the outer housing 10 is cylindrical. An interior of the outer housing 10 has a slot 101. The slot 101 has a circular shape, and is exposed at a front end of the outer housing 10. The slot 101 allows insertion of the inner housing 1 of the first connector 100, and the sealing ring 14 is arranged between the inner housing 1 and the outer housing 10 to improve a sealing effect. Two locking grooves 102 are disposed on an outer side of the outer housing 10.

The second power module 20, the second signal module 30, and the second coaxial module 40 are disposed in the outer housing 10, and are arranged to be sequentially stacked. The second signal module 30 is arranged between the second power module 20 and the second coaxial module 40. The second power module 20, the second signal module 30, and the second coaxial module 40 are connected to a second wire 60.

The second power module 20, the second signal module 30, and the second coaxial module 40 are connector modules, and each include an appropriate number of terminals for transmission of power, signals, etc. A third metal shielding shell 301 is disposed on an outer side of the second signal module 30. The third metal shielding shell 301 is a metal shielding shell made of a metal material, and has a cuboid shape. The third metal shielding shell 301 is sleeved onto the second signal module 30, so as to provide the shielding effect.

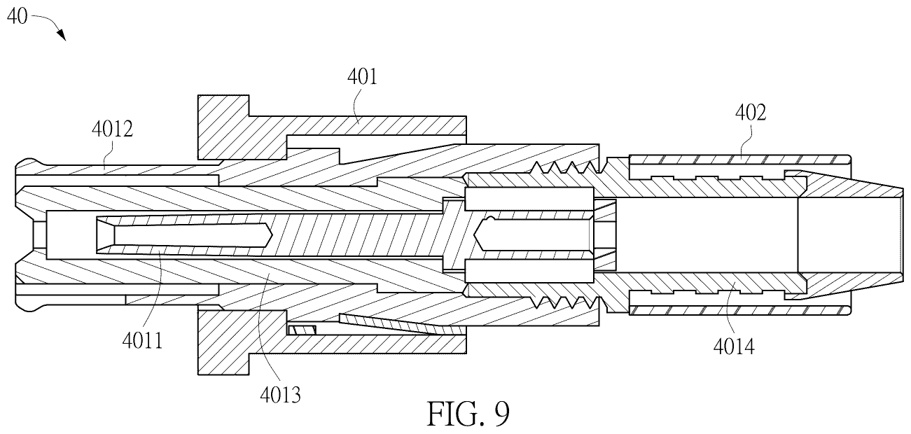

The second coaxial module 40 includes a plurality of second terminal sets 401. Each of the second terminal sets 401 includes a second shaft 4011 and a second sleeve 4012 (as shown in FIG. 9). The second shaft 4011 and the second sleeve 4012 are made of metals such as copper. The second sleeve 4012 is separately disposed outside of the second shaft 4011, and appropriate insulated isolation is formed between the second shaft 4011 and the second sleeve 4012 by a second insulator 4013. A rear end of the second sleeve 4012 is connected to a second tubular body 4014, and a fourth metal shielding shell 402 is disposed on an outer side of the second tubular body 4014. The fourth metal shielding shell 402 is a metal shielding shell made of a metal material, and is disposed at a rear end of the second shaft 4011 and that of the second sleeve 4012, so as to provide the shielding effect.

The second tail cover 50 can be made of plastic or other insulating materials. The second tail cover 50 adopts a two-piece design, and can be connected to the outer housing 10 in a snap-fit manner. The second tail cover 50 is disposed outside of the second wire 60. The second wire 60 and the second connector 200 can be fixed in the second tail cover 50 by potting. In addition, an outer shell piece 70 can be formed at an outer side of the second tail cover 50 by injection molding.

Electrical connection is achieved by mating of the first connector 100 and the second connector 200. When the first connector 100 is mated with the second connector 200, the first power module 2, the first signal module 3, and the first coaxial module 4 of the first connector 100 respectively contact and conduct with the second power module 20, the second signal module 30, and the second coaxial module 40 of the second connector 300, so as to be electrically connected. When the first connector 100 is mated with the second connector 200, the first connector 100 is lockable with the second connector 200 by the two locking portions 71 of the locking module 7 and the two locking grooves 102 of the outer housing 10. In this way, a stable engagement is formed between the first connector 100 and the second connector 200, which allows in-line locking and rotational unlocking.

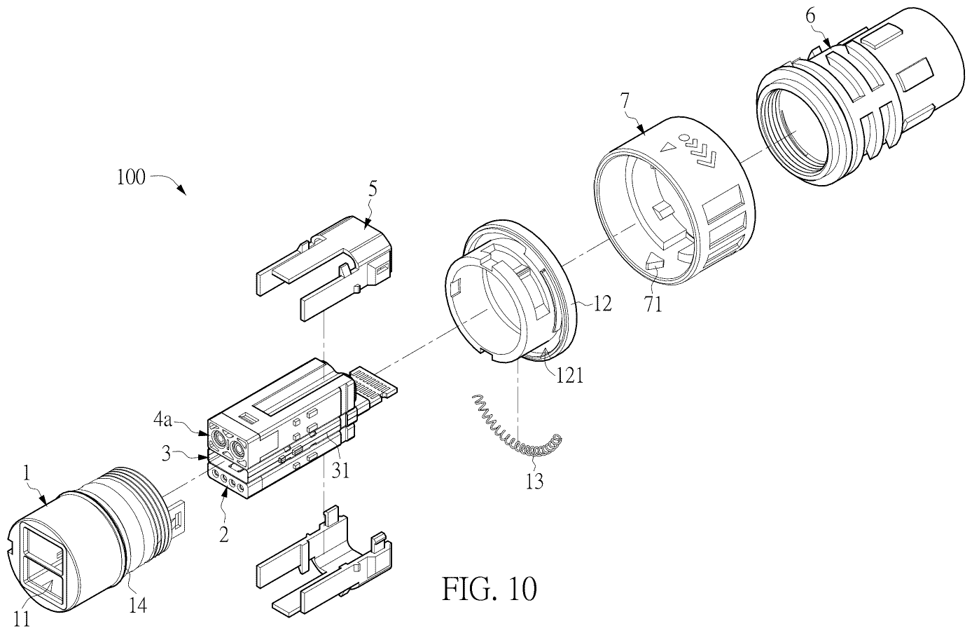

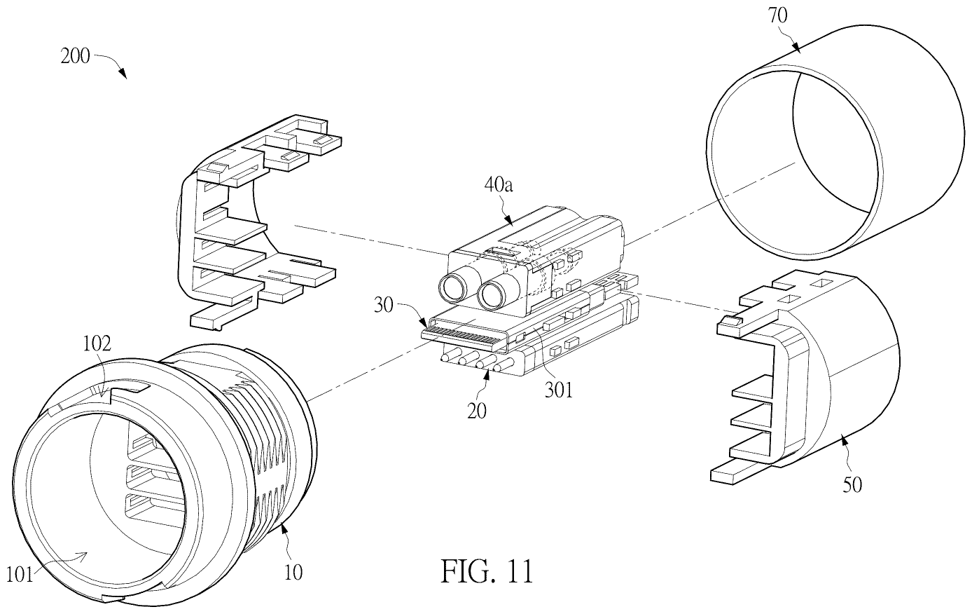

Referring to FIG. 10 and FIG. 11, a first fluid module 4a and a second fluid module 40a of the present embodiment can replace the first coaxial module 4 and the second coaxial module 40 of the above-mentioned embodiment, respectively. That is, in the present embodiment, the first connector 100 includes the inner housing 1, the first power module 2, the first signal module 3, the first fluid module 4a, the first tail cover 5, the tail tube 6, and the locking module 7, and the second connector 200 includes the outer housing 10, the second power module 20, the second signal module 30, the second fluid module 40a, and the second tail cover 50. When the first connector 100 is mated with the second connector 200, contact and conduction (communication) between the first fluid module 4a and the second fluid module 40a enable transmission of a fluid. Since other structures and functions of the present embodiment are the same as those of the above-mentioned embodiment, these details will not be reiterated herein.

### Beneficial Effects of the Embodiments

In conclusion, the pluggable connecting device provided by the present disclosure includes a first connector and a second connector. The first connector includes an inner housing, a first power module, a first signal module, a first coaxial module, a first tail cover, a tail tube, and a locking module. The first power module, the first signal module, and the first coaxial module are disposed in the inner housing, and are connected to a first wire. The first tail cover is connected to the inner housing, and is disposed outside of the first wire. The tail tube is connected to the inner housing, and is disposed outside of the first tail cover. The first wire and the first connector are fixed in the first tail cover by potting. The locking module is sleeved onto the inner housing, and is rotatable on the inner housing. The second connector includes an outer housing, a second power module, a second signal module, a second coaxial module, and a second tail cover. The second power module, the second signal module, and the second coaxial module are disposed in the outer housing, and are connected to a second wire. The second tail cover is connected to the outer housing, and is disposed outside of the second wire. The second wire and the second connector are fixed in the second tail cover by potting. When the first connector is mated with the second connector, the first power module, the first signal module, and the first coaxial module respectively contact and conduct with the second power module, the second signal module, and the second coaxial module, and the first connector is lockable with the second connector by the locking module. In the present disclosure, the first connector and the second connector are fixed with the first wire and the second wire by potting, so as to reduce the costs through component reduction and structure simplification.

Furthermore, since a first metal shielding shell is disposed on the first signal module, a second metal shielding shell is disposed on the first coaxial module, a third metal shielding shell is disposed on the second signal module, and a fourth metal shielding shell is disposed on the second coaxial module, a shielding effect can be provided. Through separate arrangement of these metal shielding shells, flexible adjustment can be made to meet different requirements in use, signal interference of different modules in the same connector can be effectively prevented, and a weight can be reduced.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A pluggable connecting device, comprising:
a first connector, wherein the first connector includes an inner housing, a first power module, a first signal module, a first coaxial module, a first tail cover, a tail tube, and a locking module, an interior of the inner housing has an accommodating space, and the accommodating space is exposed at a front end of the inner housing; wherein the first power module, the first signal module, and the first coaxial module are disposed in the accommodating space and connected to a first wire, the first tail cover is connected to the inner housing and disposed outside of the first wire, the tail tube is connected to the inner housing and disposed outside of the first tail cover, and the first wire and the first connector are fixed in the first tail cover by potting; wherein the locking module is sleeved onto the inner housing and rotatable on the inner housing, and a locking portion is disposed on an inner side of the locking module; wherein an elastic member is arranged between the locking module and the inner housing, so as to provide a rotating and resetting force to the locking module; and
a second connector, wherein the second connector includes an outer housing, a second power module, a second signal module, a second coaxial module, and a second tail cover, an interior of the outer housing has a slot, the slot is exposed at a front end of the outer housing, and a locking groove is disposed on an outer side of the outer housing; wherein the second power module, the second signal module, and the second coaxial module are disposed in the outer housing and connected to a second wire, the second tail cover is connected to the outer housing and disposed outside of the second wire, and the second wire and the second connector are fixed in the second tail cover by potting;
wherein, when the first connector is mated with the second connector, the first power module, the first signal module, and the first coaxial module respectively contact and conduct with the second power module, the second signal module, and the second coaxial module, and the first connector is lockable with the second connector by the locking portion of the locking module and the locking groove of the outer housing.

2. The pluggable connecting device according to claim 1, wherein a first metal shielding shell is disposed on an outer side of the first signal module.

3. The pluggable connecting device according to claim 1, wherein the first coaxial module includes a plurality of first terminal sets, each of the plurality of first terminal sets includes a first shaft and a first sleeve, the first sleeve is separately disposed outside of the first shaft, insulated isolation is formed between the first shaft and the first sleeve by a first insulator, a rear end of the first sleeve is connected to a first tubular body, and a second metal shielding shell is disposed on an outer side of the first tubular body.

4. The pluggable connecting device according to claim 1, wherein a third metal shielding shell is disposed on an outer side of the second signal module.

5. The pluggable connecting device according to claim 1, wherein the second coaxial module includes a plurality of second terminal sets, each of the plurality of second terminal sets includes a second shaft and a second sleeve, the second sleeve is separately disposed outside of the second shaft, insulated isolation is formed between the second shaft and the second sleeve by a second insulator, a rear end of the second sleeve is connected to a second tubular body, and a fourth metal shielding shell is disposed on an outer side of the second tubular body.

6. The pluggable connecting device according to claim 1, wherein a sealing ring is sleeved onto an outer side of the inner housing, and the sealing ring is arranged between the inner housing and the outer housing when the first connector is mated with the second connector.

7. The pluggable connecting device according to claim 1, wherein a ring base is disposed on an outer side of the inner housing, the ring base has an accommodating groove, the elastic member is disposed in the accommodating groove, the locking module is disposed outside of the ring base, and the elastic member is arranged between the ring base and the locking module.

8. A pluggable connecting device, comprising:
a first connector, wherein the first connector includes an inner housing, a first power module, a first signal module, a first fluid module, a first tail cover, a tail tube, and a locking module, an interior of the inner housing has an accommodating space, and the accommodating space is exposed at a front end of the inner housing; wherein the first power module, the first signal module, and the first fluid module are disposed in the accommodating space and connected to a first wire, the first tail cover is connected to the inner housing and disposed outside of the first wire, the tail tube is connected to the inner housing and disposed outside of the first tail cover, and the first wire and the first connector are fixed in the first tail cover by potting; wherein the locking module is sleeved onto the inner housing and rotatable on the inner housing, and a locking portion is disposed on an inner side of the locking module; wherein an elastic member is arranged between the locking module and the inner housing, so as to provide a rotating and resetting force to the locking module; and
a second connector, wherein the second connector includes an outer housing, a second power module, a second signal module, a second fluid module, and a second tail cover, an interior of the outer housing has a slot, the slot is exposed at a front end of the outer housing, and a locking groove is disposed on an outer side of the outer housing; wherein the second power module, the second signal module, and the second fluid module are disposed in the outer housing and connected to a second wire, the second tail cover is connected to the outer housing and disposed outside of the second wire, and the second wire and the second connector are fixed in the second tail cover by potting;
wherein, when the first connector is mated with the second connector, the first power module, the first signal module, and the first fluid module respectively contact and conduct with the second power module, the second signal module, and the second fluid module, and the first connector is lockable with the second connector by the locking portion of the locking module and the locking groove of the outer housing.

9. The pluggable connecting device according to claim 8, wherein a first metal shielding shell is disposed on an outer side of the first signal module.

10. The pluggable connecting device according to claim 8, wherein a third metal shielding shell is disposed on an outer side of the second signal module.

11. The pluggable connecting device according to claim 8, wherein a sealing ring is sleeved onto an outer side of the inner housing, and the sealing ring is arranged between the inner housing and the outer housing when the first connector is mated with the second connector.

12. The pluggable connecting device according to claim 8, wherein a ring base is disposed on an outer side of the inner housing, the ring base has an accommodating groove, the elastic member is disposed in the accommodating groove, the locking module is disposed outside of the ring base, and the elastic member is arranged between the ring base and the locking module.
